(19) United States
(12) Patent Application Publication
(10) Pub. No.: US 2018/0003156 A1
(43) Pub. Date: Jan. 4, 2018

(54) POWER PRODUCING WALLS

(71) Applicants: Nicholas Constan CHRIST, Charleston, SC (US); Stefan VARGA, Maribor (SI)

(72) Inventors: Nicholas Constan CHRIST, Charleston, SC (US); Stefan VARGA, Maribor (SI)

(21) Appl. No.: 15/636,873

(22) Filed: Jun. 29, 2017

Related U.S. Application Data
(60) Provisional application No. 62/356,013, filed on Jun. 29, 2016.

(51) Int. Cl. F03D 9/25; F03D 13/20; H02K 7/18; F03D 3/00; F03D 9/00

(52) U.S. Cl. CPC F03D 9/25; F03D 3/005; F03D 9/007; H02K 7/183; F03D 13/20; F05B 2240/217; F05B 2280/10; F05B 2280/4003; F05B 2280/6003; F05B 2260/421

(57) ABSTRACT

A power generating wall design, which may include a plurality of turbines, such as wind turbines, arranged in a wall pattern and arranged to have an entrance flow on one side of the wall and an exit flow on another side of the wall. One exemplary embodiment of a power generating wall may incorporate wind turbines, and may be used in a high-wind environment, such as a highway. In another exemplary embodiment, a power generating wall may incorporate other types of turbines, such as water-driven turbines, and may be constructed in a location that is wholly or partially underwater, such as a river or tidal basin.

### CROSS-REFERENCE TO RELATED APPLICATIONS

This application claims priority from U.S. Provisional Patent Application No. 62/356,013, filed on Jun. 29, 2016, entitled “Power Producing Walls,” the entire contents of which are hereby incorporated by reference.

### BACKGROUND

There has been an increasing need for electrical power to be provided to roadways, particularly in rural and more isolated areas. One reason for this is an increasing recognition of the importance of street lighting and of the inadequacy of most existing vehicular lighting. Poor lighting is widely understood to be a highway hazard, and a recent study by the Insurance Institute for Highway Safety found that the headlights of almost all vehicles are less than adequate, with the headlights on only one vehicle out of thirty-one earning a “good” rating. See, for example, Insurance Institute for Highway Safety, In the Dark: New Ratings Show Most Headlights Need Improvement (2016), available at http://www.iihs.org/externaldata/srdata/docs/sr5103.pdf. However, it is generally not economical to provide roadside lighting on many stretches of road, in large part because many stretches of road—particularly high-traffic ones—intentionally run through underpopulated areas far from power infrastructure.

The need for electrical power to be provided near roadways has also been heightened by the increasing popularity of electric cars. While such vehicles have many potential advantages over the gasoline-powered variety, one area in which they are heavily lacking is operating range; most electric cars are not equipped to travel for a significant distance without requiring a recharge of their battery. While electric vehicle charging infrastructure is quickly growing, it is still heavily lacking in rural or more isolated areas, for similar reasons to those discussed previously.

There have been a number of proposals for how to use roadways themselves to capture some quantity of energy. Some proposals have recognized that renewable energy generation can be built into the roads themselves; for example, photovoltaic cells can be implanted into the roads and used to generate power, or a solar thermal system can be incorporated into the asphalt. Other proposals have focused on harvesting energy from traffic; for example, a number of piezoelectric cells might be incorporated into a road such that when a vehicle passes over and compresses the piezoelectric cell, power is generated. Other proposals have focused on wind power generation.

Motor vehicles typically expend a significant amount of energy in overcoming air resistance. As the air resistance on a body typically varies with the velocity of the body, this means that the effects of air resistance are higher on vehicles that are traveling at higher speeds. This means that, near highways and other roads that see a significant volume of high-speed traffic, there is often a significant amount of continuous air movement due to the high volume of motor vehicles traveling through the area.

There are certain advantages to using wind power generation to provide power to roadways or to surrounding areas. Traffic flow tends to be fairly predictable, and as such the winds caused by traffic flow tend to be significantly more predictable than more natural winds might be. This makes it significantly easier to determine the peak power output that will be generated by wind turbines on a roadway, significantly simplifying power management. The infrastructure needed to harvest electrical power from wind created from the motion of traffic can also be used to generate electrical power from natural wind, ensuring that there is at least some level of electrical power generation at almost all times of the day.

Certain problems have, however, prevented the widespread adoption of traffic-based wind power generation. One problem is that existing wind power infrastructure is typically large and difficult to install quickly; local governments have very little incentive to shut down their most heavily-trafficked roadways for days or weeks at a time in order to install wind generators where they would be most suited. Overhead or over-road wind turbines can also conceivably be dangerous, or have the appearance of being dangerous; a small number of fatalities are caused almost every year by wind turbine accidents, such as blade failures, and many drivers may prefer not to have to drive under a heavy set of spinning blades on their way to work every morning. Existing wind generators can also be somewhat inefficient uses of space, and can be somewhat unsightly as well.

### SUMMARY

According to an exemplary embodiment, a power generating wall design may be disclosed. A power generating wall may include a plurality of turbines, such as wind turbines, arranged in a wall pattern and arranged to have an entrance flow on one side of the wall and an exit flow on another side of the wall. In an exemplary embodiment, a power generating wall may incorporate wind turbines, and may be used in a high-wind environment, such as a highway. In another exemplary embodiment, a power generating wall may incorporate other types of turbines, such as water-driven turbines, and may be constructed in a location that is wholly or partially underwater, such as a river or tidal basin.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 shows an exemplary embodiment of a turbine rotor that may be utilized in a power generating wall.

FIG. 2 shows an exemplary embodiment of a power producing wall system.

FIG. 3 shows an exemplary embodiment of a power producing wall system having an additional power generating device.

FIG. 4 shows an exemplary embodiment of a power producing wall system having a plurality of electrical sockets that may be used to provide electrical power to other devices.

FIG. 5 shows an exemplary embodiment of a power producing wall system in a potential use environment.

FIG. 6 shows an exemplary embodiment of a power producing wall system in a potential use environment.

FIG. 7 shows an exemplary embodiment of a power producing wall system in a potential use environment.

FIG. 8 shows an exemplary embodiment of a kinetic flap design that may be integrated into a power producing wall system.

FIG. 9 shows an exemplary embodiment of a deployable power-producing wall system frame.

FIG. 10 shows an exemplary embodiment of a solar-equipped deployable power-producing wall system frame.

FIG. 11 shows an exemplary embodiment of a wind power generation unit that may be used with or integrated into a deployable power-producing wall system frame.

FIG. 12 shows an exemplary embodiment of a deployable power-producing wall system made up of wind power generation units arranged in a stack.

FIG. 13 shows an exemplary embodiment of a power-producing wall system.

FIG. 14 shows an exemplary embodiment of a power-producing wall system.

FIG. 15 shows an exemplary embodiment of a power-producing wall system.

FIG. 16 shows an exemplary embodiment of a power-producing wall system.

FIG. 17 shows an exemplary embodiment of a power-producing wall system.

FIG. 18 shows an exemplary embodiment of a building having a power-producing wall system disposed on the outside wall of the building.

FIG. 19 shows an exemplary embodiment of a power-producing wall.

FIG. 20 shows an exemplary embodiment of a power-producing wall which may be used as a barrier as well as for power production.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

According to an exemplary embodiment, and referring generally to the Figures, a power generating wall design may be disclosed. A power generating wall may include a plurality of turbines, such as wind turbines, arranged in a wall pattern and arranged to have an entrance flow on one side of the wall and an exit flow on another side of the wall.

According to an exemplary embodiment, a power generating wall may incorporate wind turbines, and may be used in a high-wind environment, such as a highway. For example, in some exemplary embodiments, a power-generating wall may be placed on a part of a roadway that sees the largest amount of wind from traffic, such as along a high-traffic stretch of road that has a high speed limit and high average traffic speed, or may be placed on a part of a roadway that sees a significant amount of wind created by the combination of natural wind and wind created by traffic, such as on a bridge or in an elevated open area. In another exemplary embodiment, a power-generating wall may be placed in a location where it receives only natural wind; for example, in an exemplary embodiment, power-generating walls may be incorporated into the top of a skyscraper in order to give the building a certain amount of renewable energy generating capacity while maintaining the general shape of the building. In some embodiments, power-generating walls may be incorporated into a highway median, a sound barrier, an artistic or decorative wall or other barrier such as a privacy fence, a tunnel, a building, or another position, as desired.

In another exemplary embodiment, a power generating wall may incorporate other types of turbines, such as water-driven turbines, and may be constructed in a location that is wholly or partially underwater, such as a river, a tidal basin, or the ocean floor. In some exemplary embodiments, power generating walls may be used as barriers and restrictors as well as power generating units, as desired. For example, an exemplary embodiment of a power generating wall may be used as a structural support for a pier, or may otherwise be attached to the pier, and may catch the incoming and outgoing tides, generating electrical power.

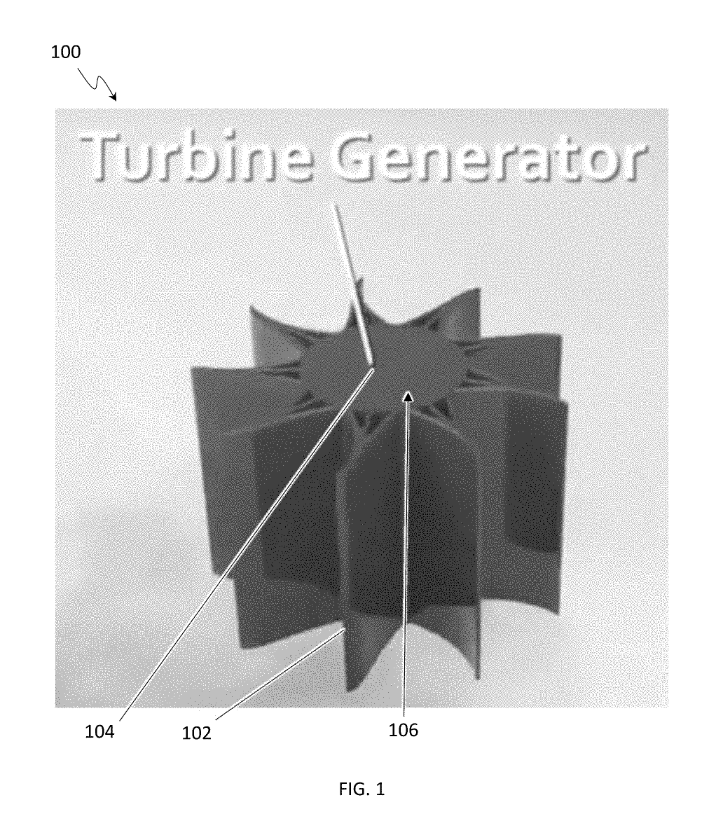

Turning now to exemplary FIG. 1, an exemplary embodiment of a turbine rotor 100 that may be used in a power generating wall design may be disclosed. In such an embodiment, a turbine rotor 100 may include a central portion 104, such as a vertically-disposed shaft or axis, about which the turbine rotor 100 may rotate. Turbine rotor 100 may also have a number of blades 102 disposed around the circumference of the turbine rotor 100.

In an exemplary embodiment, a turbine rotor 100 may be an element of a cross-flow turbine or vertical-axis wind turbine (VAWT), in which air, water, or another fluid may be passed through the turbine rotor 100 transversely in order to rotate the turbine rotor 100 around its axis 104. In an exemplary embodiment, the turbine rotor 100 may be formed as a single part, and each end 106 of the turbine rotor 100 may be coupled to a mechanism, such as a shaft, which may in turn be coupled to a generator. In another exemplary embodiment, the turbine rotor 100 may include one or more magnetic rotors disposed on one end 106 or on each end 106, which may be coupled to the ends 106 of the turbine rotor 100 or mounted inside hollow portions of the ends 106 of the turbine rotor 100, as desired. In another embodiment, the turbine rotor 100 may include a hole or slot in which a shaft can be placed, such that the turbine rotor 100 may operate to rotate the shaft when turned. In another embodiment, the turbine rotor 100 may have a hollow or substantially hollow central portion, such as in a “squirrel cage” turbine, which may allow a fluid to pass directly through the turbine rotor 100, if desired. In another embodiment, turbine rotor 100 may have another geometry, as desired.

In some exemplary embodiments, a turbine rotor 100 may have a variant number of blades 102 disposed about the circumference; for example, in one exemplary embodiment, a turbine 100 may have nine blades 102, though different numbers of blades 102 may also be used instead. Blades 102 may have any of a variety of shapes; for example, in an exemplary embodiment, blades 102 may be triangular, may be flat, may be airfoil-shaped, or may have another shape, as desired. In an exemplary embodiment, the ends of the turbine blades 102 may be sharpened in order to reduce resistance to the flow of air or another fluid to be passed through the turbine, if desired.

In an exemplary embodiment, a turbine rotor 100, or a portion of the turbine rotor 100 such as the blades 102, may be constructed from a polymer, a composite such as CFRP or another composite, or another lightweight material, as desired. This may ensure that the turbine rotor 100 has a low rotational inertia, which may allow the turbine rotor 100 to accelerate quickly in the presence of wind, causing the tip speed ratio (the ratio between the speed of the tips of the blades and the speed of the wind) of the turbine rotor 100 to be more consistent. This may improve the efficiency of the turbine rotor 100 under circumstances where the wind applied to the turbine rotor 100 is intermittent; this may be suitable for a turbine rotor 100 that is to be placed in, for example, a more isolated rural area where traffic is more intermittent, or which is intended to be powered to some significant extent by natural wind as well as the wind created by moving traffic. In another exemplary embodiment, the turbine rotor 100 may be constructed to have a higher moment of inertia in order to improve the consistency of power output. The turbine rotor 100 may also be coupled to another component of a turbine having a higher moment of inertia; for example, in an exemplary embodiment, the turbine rotor 100 may impart angular momentum to a flywheel, which may in turn be used to generate electrical power.

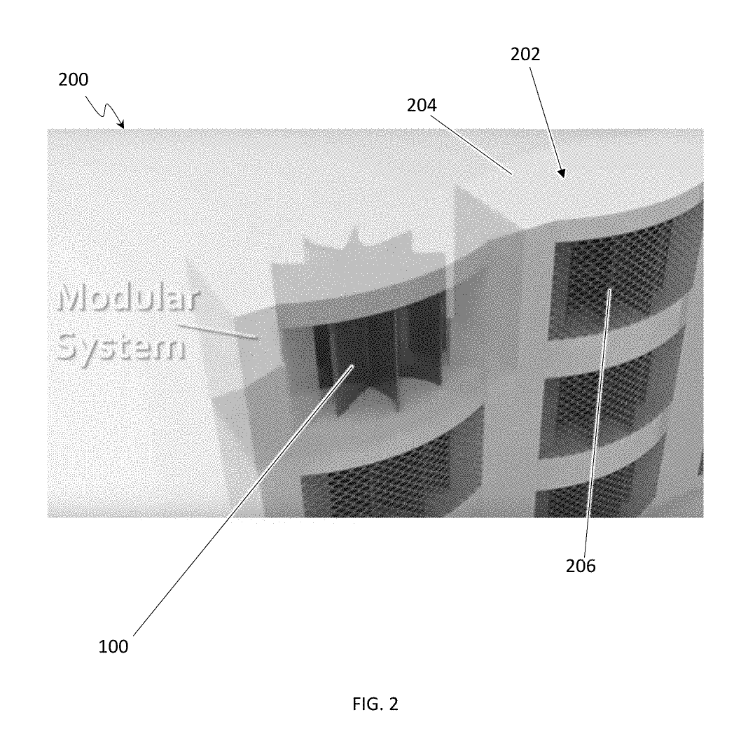

Turning now to exemplary FIG. 2, FIG. 2 shows an exemplary embodiment of a power producing wall system 200. A power producing wall system 200 may include one or more turbines 202, each of the turbines 202 including a turbine rotor 100, an exemplary casing or enclosure 204 in which a turbine rotor 100 may be housed, and potentially a filter or grate 206 that may be used to keep debris or large debris out of the turbine 202 mechanism. In an exemplary embodiment, the casing or enclosure 204 of a turbine 202 may be open on two or more faces or ends, which may allow a fluid, such as wind or water, to pass through the turbine 202. For example, in one exemplary embodiment, a power producing wall system 200 that is intended to be used on a roadway may have a front face of a casing or enclosure 204 open to the environment, optionally protected with a filter or grate 206, and facing in the expected direction of some or most of the wind expected to be caused by traffic moving near to the power producing wall system 200. Another face of the casing or enclosure 204, such as the rear face, may likewise be open to the environment, such that wind caused by the traffic may pass through the turbines 202 of the power producing wall system 202, causing the turbine rotors 100 to rotate and generating electrical power. In an embodiment, a rear face of the casing or enclosure 204 may also be protected by a filter or grate 206, which may be used to, for example, prevent animals from intruding into the casing 204 or prevent the ingress of debris into the casing 204.

Filter or grate 206 may be adapted to the environment in which the power producing wall system 200 is placed; for example, in an exemplary embodiment, a filter used for a power-producing wall system 200 that makes use of wind power may be more or less permissive than a power-producing wall system 200 that makes use of water power, or may use a different type of filter medium, as desired.

In an exemplary embodiment, a power-producing wall system 200 may be modular. For example, in an exemplary embodiment, a power-producing wall system 200 may be made up of a number of interchangeable turbines 202, each of which can be connected to one or more other interchangeable turbines 202. For example, in an exemplary embodiment, individual turbines 202 may be stacked on top of each other to a desired height, and may be connected with connectors disposed on the top and bottom of the casing or enclosure 204 of each turbine 202. In another exemplary embodiment, stacks of turbines 202 may be interchangeable with other stacks of turbines 202, and may be connected to other stacks of turbines 202 to the left or the right of each stack of turbines 202. In some exemplary embodiments, turbines 202 may be individually or jointly linked to energy storage mechanisms, such as batteries or flywheels, and may be connected in series or in parallel, as desired. In an exemplary embodiment, turbines 202 at the lowermost portion of the stack may be anchored to the ground, for example via bolts or other connectors, may be anchored to a base component that is anchored to the ground, or may be anchored to another fixture, as desired.

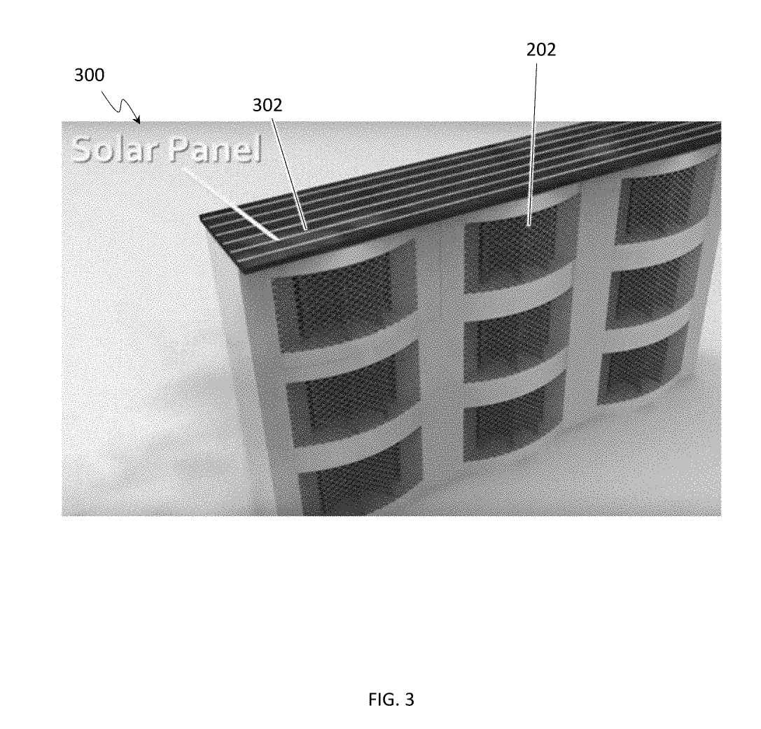

Turning now to exemplary FIG. 3, a power-producing wall system 300 may further include other devices for energy generation other than turbines 202. For example, in an exemplary embodiment, a power-producing wall system 300 may incorporate a solar panel 302 disposed along the top portion of a set of turbines 202. This may ensure that the topmost portion of a power-producing wall system 300 is also being used for power generation, maximizing the space efficiency of the power-producing wall system 300. In some exemplary embodiments, a solar panel 302 may also be disposed along a top portion of a set of turbines 202 in order to better protect it, for example from the surrounding environment. For example, in an exemplary embodiment, the power-producing wall system 300 may be placed on a highway median, and a solar panel 302 may be placed on top of the power-producing wall system 300, which may help to keep the solar panel 302 clean of particulate matter that may be thrown up into the air by vehicles driving nearby.

In other exemplary embodiments, other devices for generating electrical power other than photovoltaic solar panels 302 may be understood and may be used in conjunction with a power-producing wall system 300. For example, in an exemplary embodiment, a power-producing wall system 300 including a number of vertical-axis wind turbines 202 may itself serve as a support for a larger wind turbine, such as a horizontal wind turbine, with the power-producing wall system 300 serving to raise the larger wind turbine out of the level of traffic. In another exemplary embodiment, a road may be converted into a thermal solar generation system in which the surface of the road is converted into a solar thermal collector, and generation machinery may be located near the road and enclosed by power-producing wall systems for purposes of space efficiency.

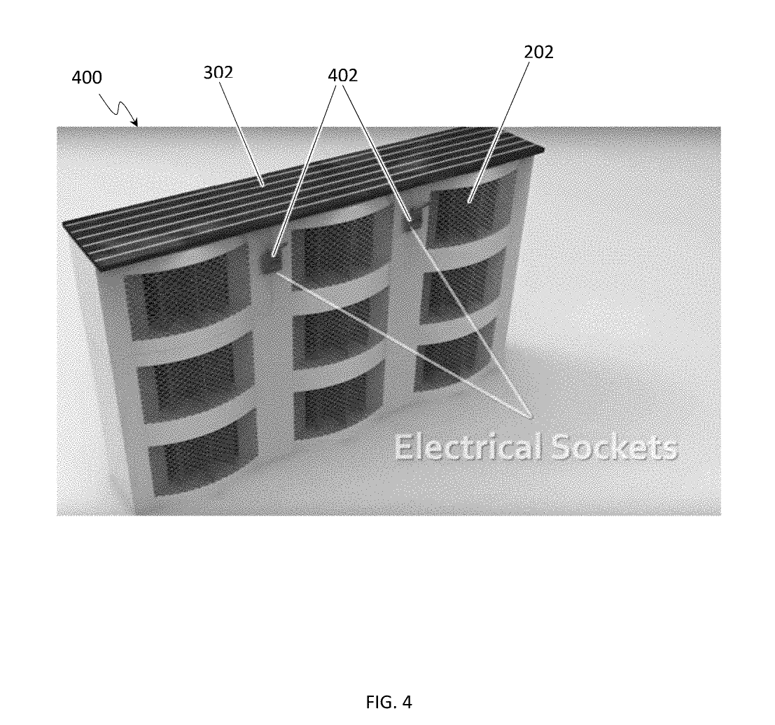

Turning now to exemplary FIG. 4, a power-producing wall system 400 may also be coupled to other devices other than solar panels 302 or other devices for generating electrical power.

For example, according to an exemplary embodiment, a power-producing wall system 400 may include one or more electrical sockets 402 disposed on the power-producing wall system 400, for example interspersed between a plurality of turbines 202 or placed as desired, and which are provided with electrical power by the power-producing wall system 400. In an exemplary embodiment, devices receiving electrical power may be connected to one or more of these electrical sockets 402, either temporarily or permanently, as desired. For example, according to an exemplary embodiment, some or all of the electrical sockets 402 may be used to power one or more lights, which may be used to provide street illumination or streetside illumination, or may be used for other purposes, such as signaling or advertising, as desired. In another exemplary embodiment, one or more electrical sockets 402 may be provided in a vehicle-accessible position, for example in a position such that the sockets 402 can be accessed from the shoulder of the road, and may be configured to provide electrical power to a vehicle, for example an electric vehicle that has depleted its battery or a conventional vehicle that requires a jump-start.

In another exemplary embodiment, a power-producing wall system 400 may be permanently coupled to a power-consuming device, rather than being coupled to a power-consuming device via a connection at a socket 402. In some embodiments, power-consuming devices may be located on the road or may be located elsewhere. For example, in an exemplary embodiment, a power-producing wall system 400 or series thereof may be used to power an electric vehicle charging system or the facilities of a rest stop located in an isolated area, or may be used in order to power existing street lights or street lights provided as separate fixtures. Other systems, such as powered road de-icers, may also be coupled with a power-producing wall system 400, as desired.

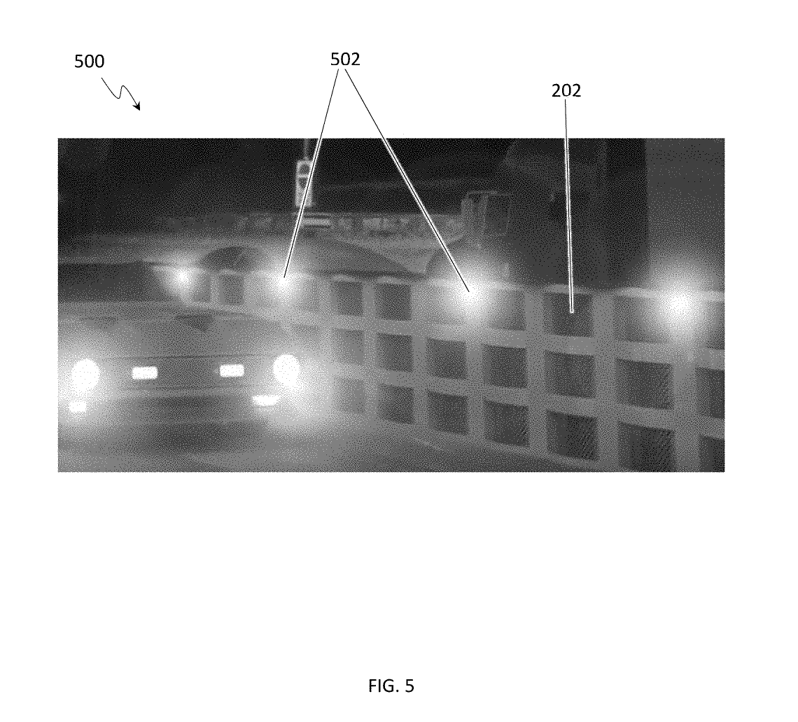

Turning now to exemplary FIG. 5, FIG. 5 shows an exemplary embodiment of a power-producing wall system 500 disposed along a highway median. According to an exemplary embodiment, a power-producing wall system may have lights 502 disposed in some or all of the electrical sockets that may be provided on the power-producing wall system 500. Lights 502 may be fixedly integrated into the power-producing wall system 500 or may be removably mounted in sockets, for example externally-accessible sockets, as desired.

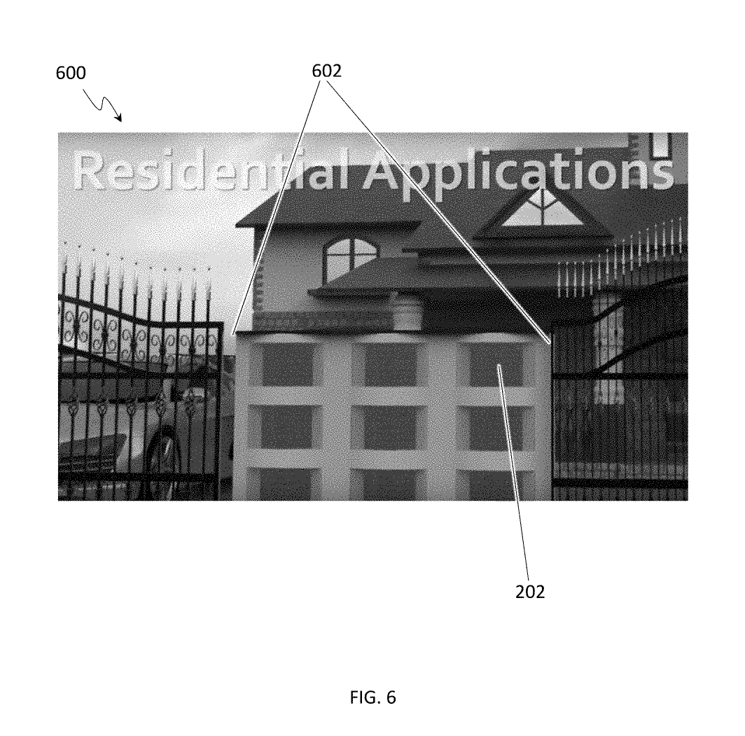

Turning now to exemplary FIG. 6, FIG. 6 shows an exemplary embodiment of a power-producing wall system 600 which may be configured for residential use or commercial use. In an exemplary embodiment, a power-producing wall system 600 may be provided as part of a fence, and may be coupled to other elements of the fence 600, as desired. In such an embodiment, power-producing wall system 600 may be constructed from a single piece rather than being modular, if desired. In an exemplary embodiment, a power-producing wall system 600 may be coupled to the electrical power system of a building, such as a residential home or commercial building, as desired, and may be used to generate power that may be provided to the building. In another exemplary embodiment, a power-producing wall system 600 may be coupled to a separate electrical system, as desired. For example, in an exemplary embodiment, a power-producing wall system 600 may be used to power outside lighting, a security system, or other devices, as desired.

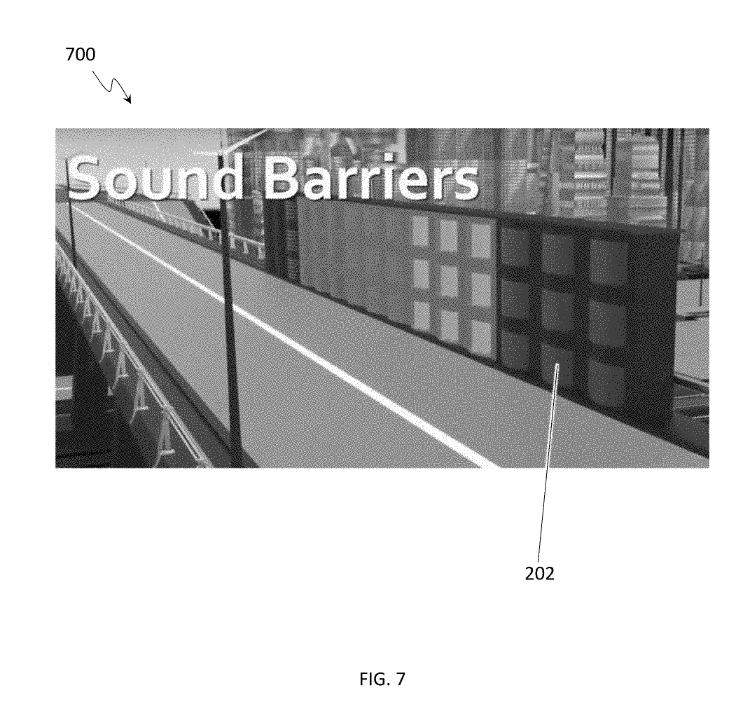

Turning now to exemplary FIG. 7, FIG. 7 shows an exemplary embodiment of a power-producing wall system 700 which may be provided in or which may be used as a sound barrier, for example in an urban environment. In an exemplary embodiment, a power-producing wall system 700 may serve as a physical barrier to sound propagation, reducing noise, and may also reduce wind noise by extracting a quantity of kinetic energy from the wind.

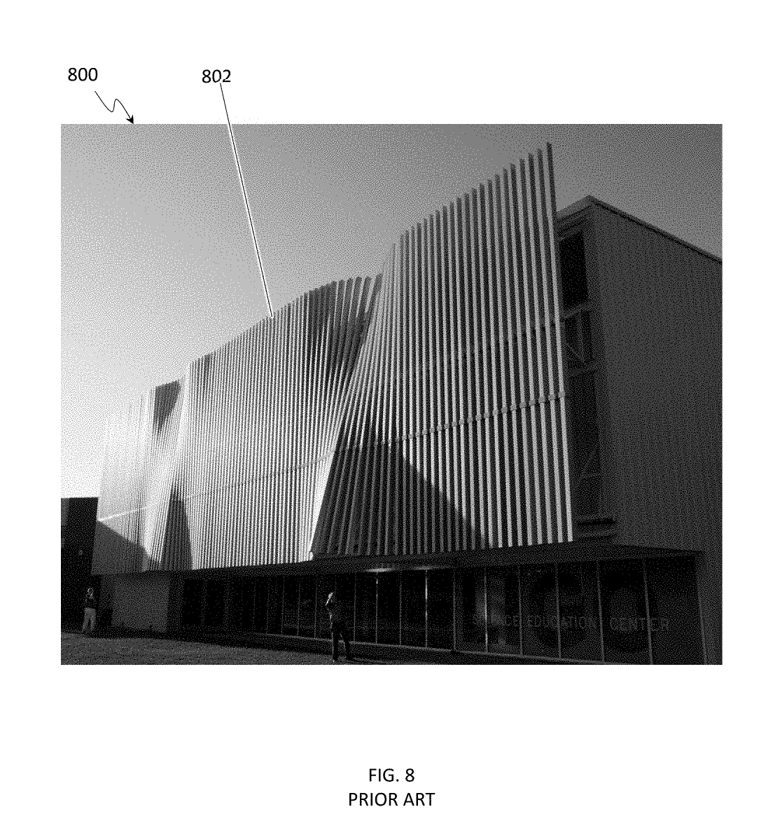

In some exemplary embodiments, a power-producing wall may make use of other mechanisms other than wind turbines in order to generate electrical power from wind, water, or another fluid, as may be desired. For example, a kinetic flap design, similar to the building-mounted kinetic pendulum design shown in exemplary FIG. 8, may be used instead. According to such an embodiment, a kinetic flap system 800 may include a plurality of wind-activated pendulums 802 or flaps that may be caused to temporarily shift in position by a gust of wind acting on the kinetic flap system 800. The motion of the flap may in turn be used to generate a quantity of electrical power. Such a system may be used for a power-producing wall in circumstances where, for example, it is undesirable to have fluid passing through the power-producing wall; for example, such a system may be used in a power-producing wall that is intended to make up the side of a building, wherein unrestricted airflow through the building would be undesirable. In another embodiment, such a system may be used in circumstances where, for example, fluid may not be able to pass through the wall because of other restrictions; for example, in an exemplary embodiment, such a system may be used to generate electrical power from wind generated by traffic in an underground tunnel, where space may be particularly tight and where the power producing wall may be integrated into the walls of the tunnel.

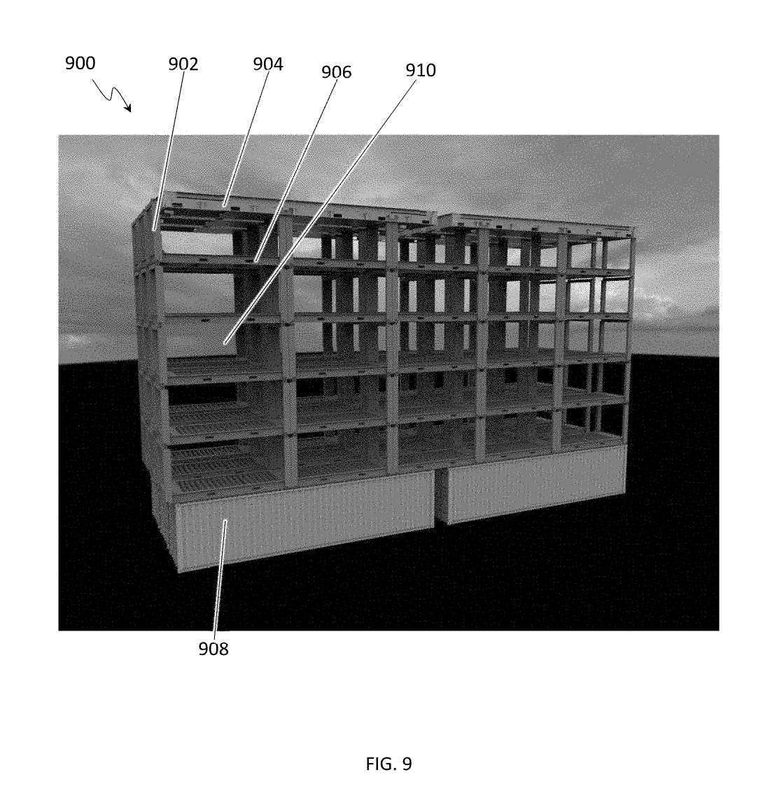

In some exemplary embodiments, power-producing wall systems may be mobile or may otherwise be deployable. Turning now to exemplary FIG. 9, FIG. 9 shows an exemplary embodiment of a deployable power-producing wall system frame 900. The frame 900 of a deployable power-producing wall system may include a plurality of vertical supports 902, a plurality of top platforms 904, and a plurality of lower platforms 906. The frame 900 of the deployable power-producing wall system may also include or may be coupled to a shipping container 908 or a plurality of shipping containers 908; for example, in an exemplary embodiment, the support portions 902, 904, 906 of the frame may rest atop one or more shipping containers 908.

In an exemplary embodiment, a deployable power-producing wall system frame 900 may include a plurality of cells 910, which may be formed by the vertical supports 902, top platforms 904, and/or lower platforms 906. In an exemplary embodiment, cells 910 may have two or more sides, such as the front and back side of the cell 910, open to the environment, which may allow the passage of air or another fluid through the cell 910 from one open side to another open side. This may allow each of the cells 910 to house one or more wind turbines or other turbines, if desired.

In some exemplary embodiments, a deployable power-producing wall system frame 900 may be modular, with individual modules constituting a cell 910 or an arrangement of cells 910. For example, in an exemplary embodiment, each cell 910 may be an individual unit, which may have, for example, a lower platform 906 and a plurality of vertical supports 902 which may face upward and upon which another cell 910 can be placed. This may allow cells 910 to be stacked several cells 910 high, before being capped with a top platform 904 piece when stacked to a desired height. In another exemplary embodiment, another arrangement of modular cells 910 may be envisioned. In another exemplary embodiment, a deployable power-producing wall system frame 900 may be formed from contiguous supports, such as contiguous vertical supports 902, lower platforms 906, and/or top platforms 904, which may be connected to each other in order to assemble them into a frame 900. In another embodiment, a combination of modular cells 910 and contiguous supports or contiguous platform pieces may be used; for example, in an exemplary embodiment, modular cells 910 may be used to form the bulk of the frame apart from the top platforms 904, which may be separate pieces more than one cell 910 in length.

In an exemplary embodiment, one or more shipping containers 908 may be integrated into a deployable power-producing wall system frame 900. For example, in an exemplary embodiment, the lowermost portion of the frame 900 may include one or more shipping containers 908 on which the rest of the frame 900 rests. In an exemplary embodiment, shipping containers 908 may be used to house energy storage for a deployable power-producing wall system that makes use of the frame 900; for example, in some exemplary embodiments, the one or more shipping containers 908 may house one or more batteries, one or more heat storage devices, one or more flywheels, or any other energy storage devices that may be desired. In some exemplary embodiments, shipping containers 908 may also serve a structural role; for example, in an exemplary embodiment, a shipping container 908 that is attached to other elements of a deployable power-producing wall system frame 900 may be used as a counterweight or foundation for the rest of the frame 900, and may be be filled with material or sunk beneath the ground, if desired.

In an exemplary embodiment, a deployable power-producing wall system that may make use of a deployable power-producing wall system frame 900 may be used for, for example, rapidly deploying a power system anywhere in the world accessible by vehicular traffic. This may be used for, for example, providing power systems to remote areas, such as rural areas in countries with poor rural infrastructure, or may be used for, for example, disaster relief.

In an exemplary embodiment, deployment of the power-producing wall system may be accomplished by ship, such as a container ship or a barge, and truck, such as a standard freight truck. In another embodiment, deployment of a deployable power-producing wall system may be accomplished with any other freight-hauling vehicles, such as cargo aircraft, as may be desired. For example, in an exemplary embodiment, parts may be sized such that they can fit inside a standard shipping container 908 that can be transported by one of these vehicles; in some exemplary embodiments, standard shipping containers 908, including standard shipping containers 908 that may be used to transport other parts of the frame 900, may be used as part of the frame 900, as desired.

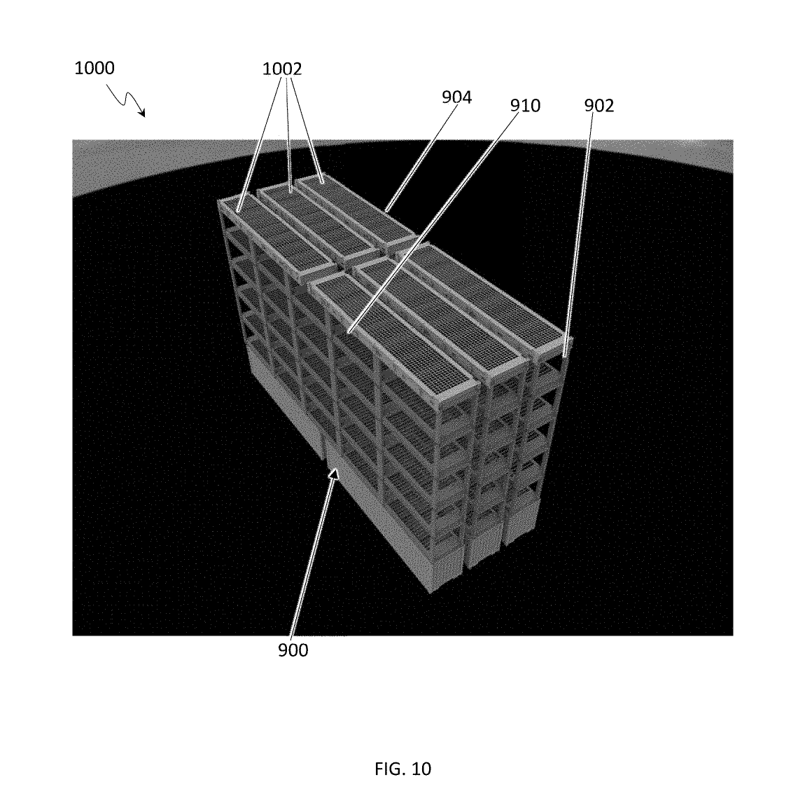

Turning now to exemplary FIG. 10, FIG. 10 shows an exemplary embodiment of a solar-equipped deployable power-producing wall system frame 1000. Said solar-equipped deployable power-producing wall system frame 1000 may include a plurality of solar panels 1002 or other solar power generation devices mounted on the top platforms 904 of the deployable power-producing wall system frame 900 of the previous embodiment.

In an exemplary embodiment, electrical conductors may be integrated into the frame 900. For example, in an exemplary embodiment, the vertical supports 902 of the frame 900, or another component making up the cells 910 of the frame 900, may be hollow or may otherwise be used to run electrical wiring from the solar panels 1002 or other electrical generation devices to one or more energy storage devices located inside shipping containers 908 or which are otherwise nearby to or accessible to the deployable power-producing wall system. In another exemplary embodiment, a solar power system other than photovoltaic solar may be used, and pipes or other energy conductors may be integrated into the vertical supports 902 or cells 910 instead. For example, in an exemplary embodiment, a deployable power-producing wall system may make use of thermal solar power generation, and heated working fluid (such as hot water) may be conducted through pipes from the upper portions of the frame 900 to one or more energy storage devices.

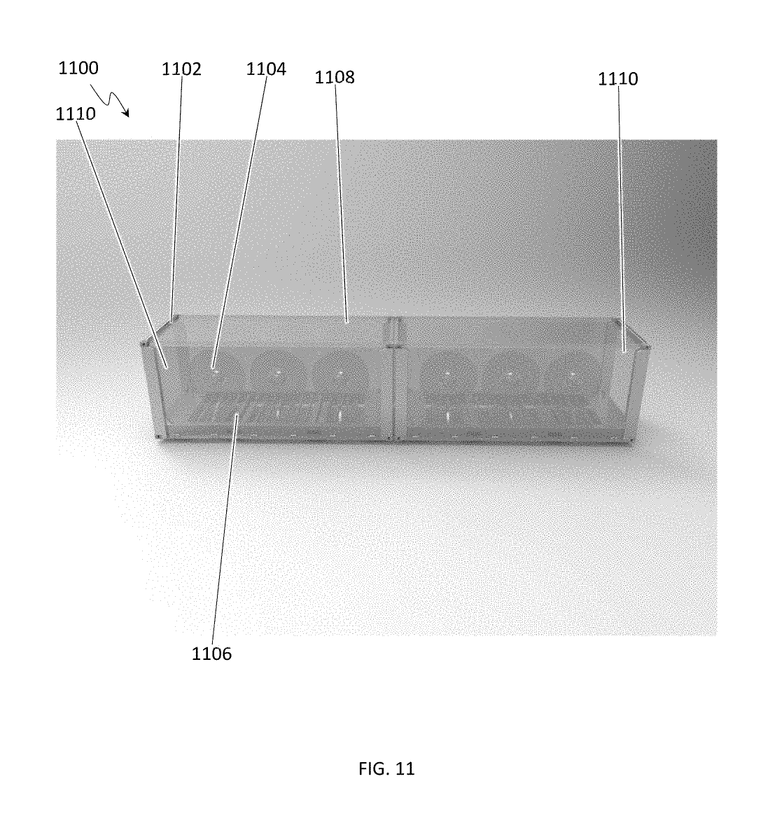

Turning now to exemplary FIG. 11, FIG. 11 shows an exemplary embodiment of a wind power generation unit 1100 that may be used with or integrated into a deployable power-producing wall system frame 900. Wind power generation unit 1100 may house one or more wind turbines 1104, and may include, for example, one or more unit vertical supports 1102, a unit lower platform 1106, and a unit upper platform 1108. Wind power generation unit 1100 may also include one or more sidewalls 1110. In an exemplary embodiment, a wind power generation unit 1110 may be open to the environment on two or more faces, such as a front or back face, which may allow air or another fluid to pass through the wind turbines 1104 or any other turbines that may be housed within the wind power generation unit 1100. (For example, in an exemplary embodiment, a deployable power-producing wall system frame 900 may be developed and constructed such that it may be sunk into water and may make use of water flow instead of air flow, if desired.)

In an exemplary embodiment, a wind power generation unit 1100 may be sized to fit within one or more of the cells of a deployable power-producing wall system frame 900. According to an exemplary embodiment, all or part of a frame 900 may first be constructed, such that a plurality of cells 910 are accessible and equipped to receive one or more wind power generation units 1100. Wind power generation units 1100 may then be supplied in some or all of the cells 910. This may allow the wind power generation units 1100 to be transported separately from the structural material of the frame 900 while still allowing self-contained wind power generation units 1100 to be used, which may ease shipping requirements and allow larger wind power generation units 1100 to be successfully shipped.

In another exemplary embodiment, a wind power generation unit 1100 may be integrated into a modular cell 910. For example, the lower platform 1108 of the wind power generation unit 1100 may be the lower platform 906 of a cell 910, and one or more vertical supports 1102 of the wind power generation unit 1100 may be one or more vertical supports 902 of a cell 910. The vertical supports 1102 of a wind power generation unit 1100 may be coupled to or otherwise used to support the lower platform 1108 of another wind power generation unit 1100 which may be placed atop the first in a stack.

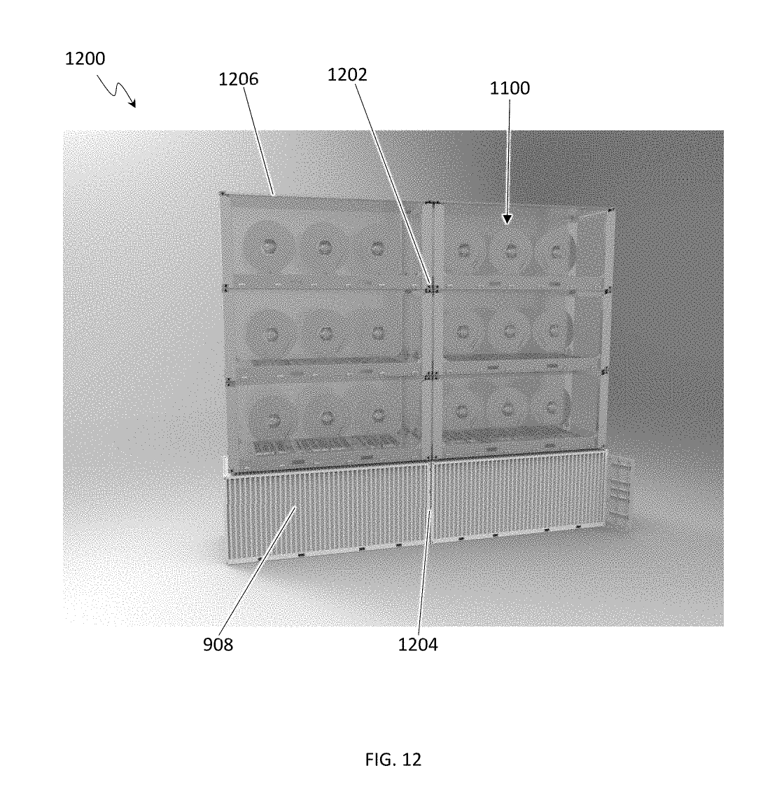

Turning now to exemplary FIG. 12, FIG. 12 shows an exemplary embodiment of a deployable power-producing wall system 1200 made up of wind power generation units 1100 arranged in such a stack. In an exemplary embodiment, wind power generation units 1100 each having a lower platform 1108 and a plurality of vertical supports 1102 may be arranged such that some of the plurality of vertical supports 1102 of the wind power generation units 1100 contact the lower platforms 1108 of other wind power generation units 1100. Wind power generation units 1100 may also be in contact with other wind power generation units 1100 on each side, apart from the sides left open to allow for air or fluid flow, and may be coupled to the other wind power generation units 1100 at one or more of the points wherein the two wind power generation units 1100 are in contact. For example, in an exemplary embodiment, wind power generation units 1100 may be connected in a grid pattern, and may be coupled to the other wind power generation units 1100 where the corners of the wind power generation units 1100 meet, such as at point 1202.

In an exemplary embodiment, wind power generation units 1100 may be supported by one or more storage containers 908. In an exemplary embodiment, storage containers 908 may also be linked together at each end 1204, as desired; the combined storage containers 908 may be used to accommodate a single linked energy storage system, such as a series of batteries, flywheels, or thermal storage tanks, instead of several dispersed energy storage systems; a single combined system may be easier to maintain and control.

In an exemplary embodiment, the topmost portions of a deployable power-producing wall system 1200, such as a top platform 1206, may be used for other types of power generation, such as photovoltaic solar power generation, or may be used for other purposes, as desired. For example, in an exemplary embodiment, the top platform 1206 of the deployable power-producing wall system may support one or a plurality of photovoltaic solar panels, which may be coupled to any energy storage system which may be located in the storage containers 908. In an exemplary embodiment, different types of energy storage may be available for different types of power generation; for example, an exemplary embodiment of a deployable power-producing wall system 1200 may generate and store hot water from a thermal solar system having a thermal solar collector located on the top portion 1206 of the deployable power-producing wall system, and may generate and store electrical power that is generated by one or more wind power generation units 1100.

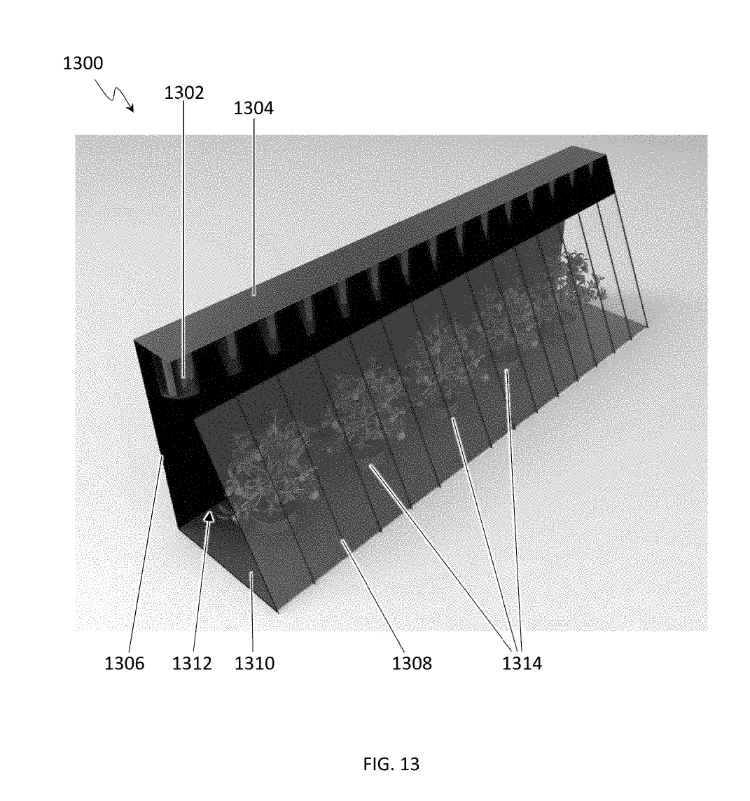

Turning now to exemplary FIG. 13, FIG. 13 shows an exemplary embodiment of a power-producing wall system 1300. According to an exemplary embodiment, a power-producing wall system 1300 may include, instead of or in addition to a solar panel or a thermal solar system, one or more passive solar systems or components. For example, according to an exemplary embodiment, a power-producing wall 1300 may be constructed so that the power-producing wall 1300 has one or more rows of turbines 1302 disposed in fluid passages 1304 (such as air passages), which may be arranged, for example, on the top part of the power-producing wall 1300. In addition, the power-producing wall 1300 may have a solar greenhouse disposed on one side of the power-producing wall 1300.

According to an exemplary embodiment, a power-producing wall 1300 may have a main load-bearing wall, such as load-bearing wall 1306, which may form one side of an enclosed solar greenhouse. Said load-bearing wall 1306 may also serve to support the turbines 1302 of the power-producing wall 1300 at a desired height. The solar greenhouse may also have, on the side opposite the load-bearing wall 1306, a sloping transparent (or translucent) wall 1308 through which light may be intended to pass. According to an exemplary embodiment, the sloping transparent wall 1308 may be permeable to light, or may be permeable to light in the light frequencies most important for photosynthesis, and may simultaneously be insulating. This may allow the sloping transparent wall 1308 to permit the passage of light while simultaneously using the sun to heat the internal space 1312 within the solar greenhouse.

According to an exemplary embodiment, the floor 1310 of the solar greenhouse may be any acceptable floor material. For example, according to an exemplary embodiment, the floor of the solar greenhouse may be bare earth, which may allow a solar greenhouse portion of a power-producing wall 1300 to be constructed more easily. In other exemplary embodiments, a floor 1310 of the solar greenhouse may be, for example, gravel, greenhouse tile, or another acceptable flooring.

According to an exemplary embodiment, one or more plants 1312 may be provided within the solar greenhouse. According to an exemplary embodiment, plants 1312 may be provided in stand-alone pots; according to another exemplary embodiment, plants 1312 may be planted in the bare earth flooring 1310 of the solar greenhouse, or may be planted in bare earth before gravel or another material is spread on the floor of the greenhouse. According to another exemplary embodiment, plants may be provided in one or more hydroponic reservoirs, such as, for example, a large continuous-flow solution culture tank which may run the length of the power-producing wall 1300 or may extend over a significant portion of the power-producing wall 1300.

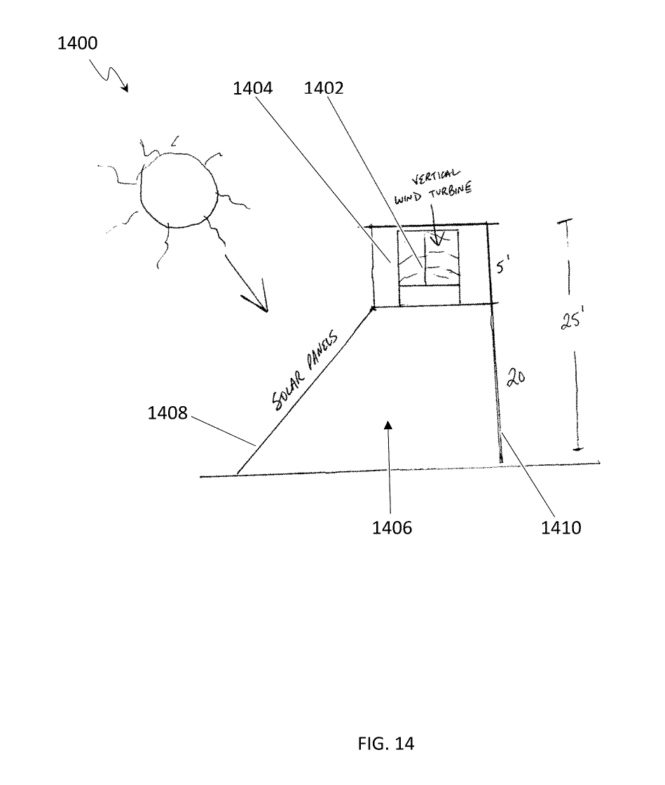

Turning now to exemplary FIG. 14, FIG. 14 may show another exemplary embodiment of a power-producing wall system 1400. According to an exemplary embodiment, a power-producing wall 1400 may have a plurality of turbines 1402, which may be, for example, vertical wind turbines 1402, disposed in a plurality of air passages 1404 or other fluid passages 1404.

According to an exemplary embodiment, a power-producing wall system 1400 may have a support base 1406, which may have one or more sloped sides 1408 and one or more straighter sides 1410. Variations may also be contemplated; for example, according to an exemplary embodiment, a power-producing wall system 1400 may be disposed on the external wall of a building, such that a sloped side 1408 serves as an external wall of the building and such that a straighter side 1410 serves as an internal wall of the building.

According to an exemplary embodiment, one or more photovoltaic solar panels or other solar systems (such as, for example, thermal solar systems, or solar mirrors oriented at a receiver, or another such system) may be disposed on a sloped side 1408 of a power-producing wall system 1400. In some embodiments, the sloped side 1408 may be oriented so that it faces the sun for a majority of the day, for example being oriented south in a northern hemisphere country or being oriented north in a southern hemisphere country.

According to an exemplary embodiment, the internal portion of the support base 1406 may be solid; in another exemplary embodiment, the internal portion of the support base 1406 may be hollow, and may house, for example, an access tunnel through which a worker may move or through which a vehicle may be driven. In an exemplary embodiment, one or more power systems may be disposed in an internal portion of the support base 1406; for example, according to an exemplary embodiment, a water pipe may be disposed through the support base 1406, and water heated by a thermal solar system may be transported through said water pipe. In another exemplary embodiment, one or more power cables may be disposed through the support base 1406 and electrical power generated by a photovoltaic solar system may be transported through said power cables.

According to an exemplary embodiment, the turbines 1402 of a power-producing wall system 1400 may be disposed at a significant distance off of the ground; for example, according to an exemplary embodiment of a power-producing wall system 1400, a turbine 1402 may be disposed at between twenty and twenty-five feet off of the ground, with the support base 1406 of the turbine 1402 having a height of twenty feet. In some exemplary embodiments, a power-producing wall 1400 may thus be functional as a barrier wall as well as a power generation source, such as may be desired.

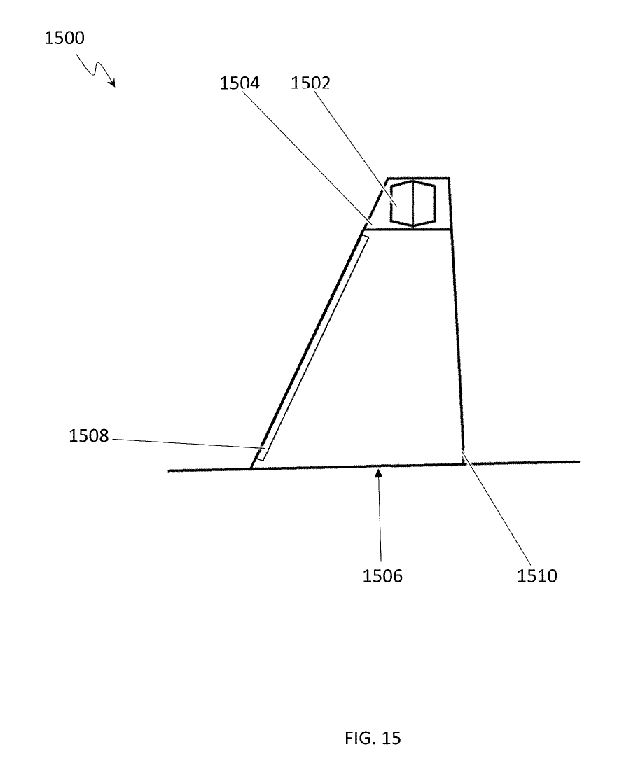

Turning next to exemplary FIG. 15, FIG. 15 shows an exemplary embodiment of a power-producing wall system 1500. According to an exemplary embodiment, a power-producing wall system 1500 may have a set of transparent solar glass disposed along a sloped side 1506 of the power-producing wall system 1500 rather than a set of solar panels as in FIG. 14. According to an exemplary embodiment, transparent solar glass 1508 may be used in order to enclose a greenhouse provided within a hollow portion of the support base 1506, which may be further defined by a vertical support 1510 which may be disposed on the opposite side of the greenhouse and which may support a turbine 1502 and an air passage 1504. In another exemplary embodiment, the transparent solar glass may be used in order to enclose, for example, a thermal solar system.

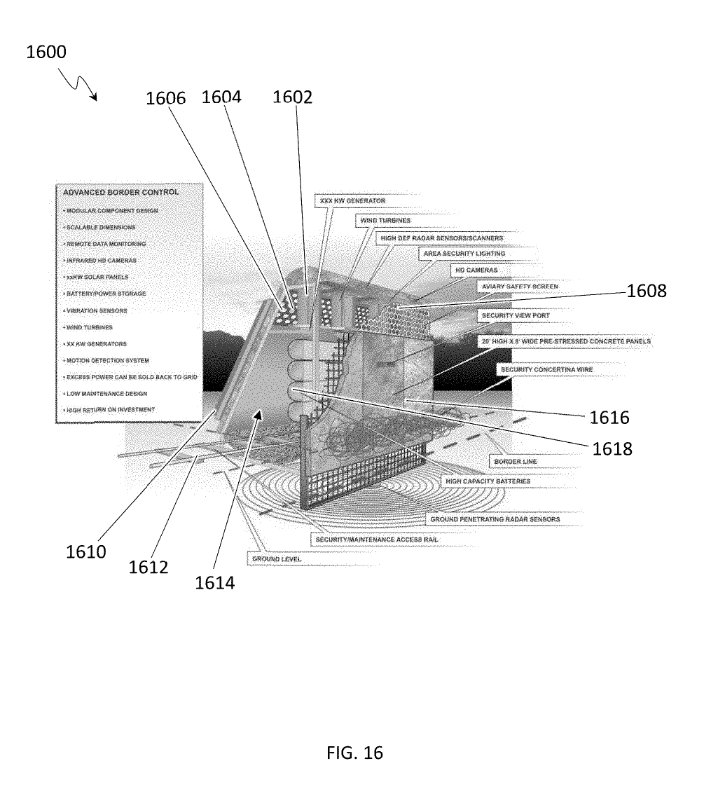

Turning next to exemplary FIG. 16, FIG. 16 shows an exemplary embodiment of a power-producing wall system 1600. According to an exemplary embodiment, a power-producing wall system 1600 may be designed to have a wind turbine 1602 which may be disposed at the top of the power-producing wall system 1600 and which may be coupled to a generator; in some exemplary embodiments, the generator may be designed to have any level of capacity, in kW, such as may be desired. In an exemplary embodiment, each turbine 1602 may be disposed in an air passage 1604 or other fluid passage 1604; according to an exemplary embodiment, each of the air passages 1604 may have an aviary safety screen 1606, 1608 disposed on each of the front end and on the back end of the power-producing wall system 1600.

According to an exemplary embodiment, the power-producing wall system 1600 may have a front wall 1616 and a rear wall 1610, on which may be mounted a plurality of solar panels. The inner portion of the support base 1614 may be hollow and may enclose a vehicle pathway, such as a maintenance access rail 1612 on which a vehicle can be moved. In some exemplary embodiments, one or more of the front wall 1616 and the rear wall 1610 may be constructed from pre-stressed concrete, for example pre-stressed concrete panels having dimensions of 20 feet high and 8 feet wide. In some exemplary embodiments, the front wall 1616 or the rear wall 1610 may be supplemented with other features such as security concertina wire in order to improve the function of the walls as walls.

According to an exemplary embodiment, the power-producing wall system 1600 may have local energy storage 1618, such as, for example, a plurality of high-capacity batteries or a flywheel, or another energy storage device or combination of devices such as may be desired. In an exemplary embodiment, a power-producing wall system 1600 may also be used to generate electrical power for on-site electrical equipment, which may in some instances be electrically connected to the power-producing wall 1600 and may in some instances be directly incorporated into the power-producing wall 1600.

For example, according to an exemplary embodiment, a power-producing wall 1600 may power one or more lights (such as one or more area security lights), may power one or more HD cameras (such as, for example, infrared HD cameras) used for security, may power a radar system (such as, for example, a high-definition radar sensor or scanner, or a ground-penetrating radar sensor), may power any other security systems such as a motion detection system or a vibration sensor, may power one or more vehicles or vehicle transport systems such as a security or maintenance access rail, may power one or more systems for transmitting data such as a wireless transmitter, or may power any other systems, such as may be desired. In an exemplary embodiment, a power-producing wall 1600 may be coupled to an electrical grid, such that the power-producing wall 1600 can provide excess power back to the grid, and can, if desired, draw power from the grid in order to power any electrical systems integrated with the wall when power produced by the power-producing wall 1600 is insufficient to run them.

In an exemplary embodiment, a power-producing wall 1600 may have a modular component design. For example, in an exemplary embodiment, each section of power-producing wall 1600 may be an independent component from each other section of power-producing wall 1600, and a power-producing wall 1600 may be installed by coupling a plurality of sections of power-producing wall 1600 next to one another.

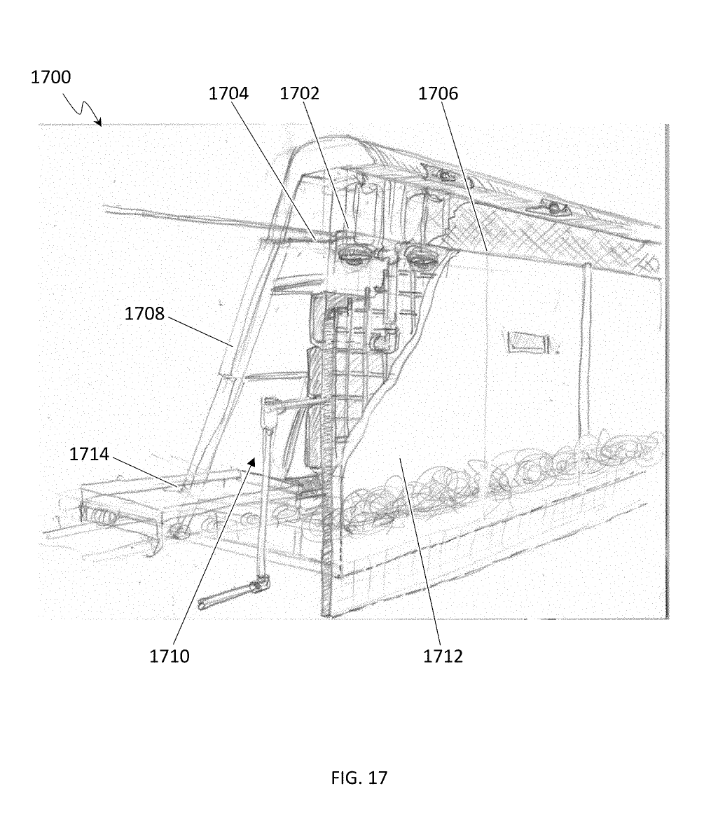

Turning now to exemplary FIG. 17, FIG. 17 shows an exemplary embodiment of a power-producing wall system 1700. According to an exemplary embodiment, a power-producing wall system 1700 may be shown with a turbine 1702, an electrical power line 1704 extending from a generator and running the length of the power-producing wall 1700, and an aviary safety screen 1706. According to an exemplary embodiment, a front wall 1712 and a rear wall 1708 of the power-producing wall system 1700 may define a cavity 1710 in which a maintenance vehicle 1714 may operate. For example, according to an exemplary embodiment, a maintenance rail may be disposed inside of the power-producing wall 1700, and a maintenance vehicle 1714 may be, for example, a draisine, speeder, handcart, or road-rail vehicle, or another vehicle capable of traversing the maintenance rail, as may be desired.

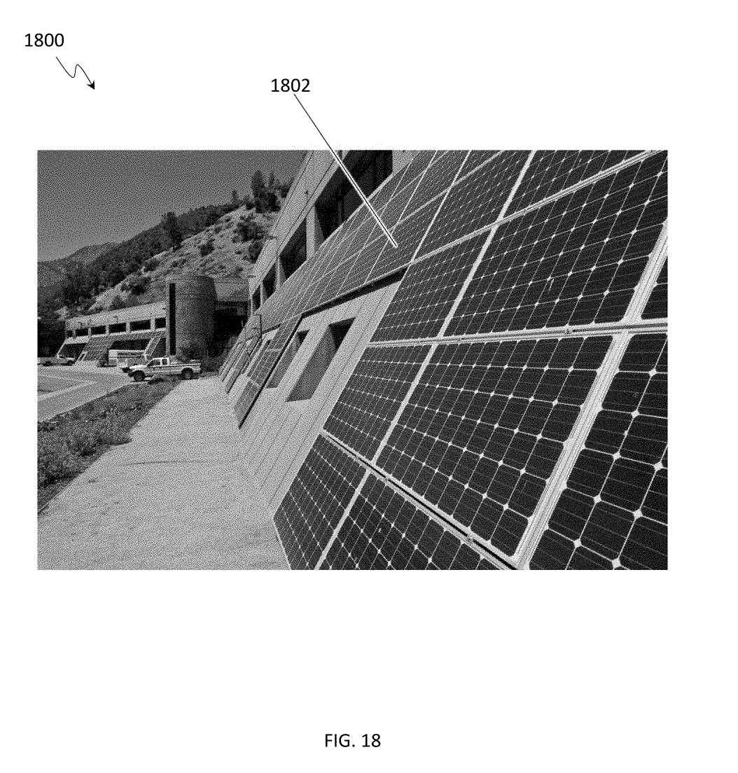

Turning now to exemplary FIG. 18, FIG. 18 shows an exemplary embodiment of a building having a power-producing wall system 1800 disposed on the outside wall of the building. According to an exemplary embodiment, the outside wall of a building may be sloped, and one or more solar panels 1802 may be disposed thereon. According to an exemplary embodiment, the outside wall of the building may continue upward and terminate in one or more wind turbines, which may, for example, be disposed on top of the roof of the building so that air can pass freely through the wind turbines without disrupting the occupants. In other exemplary embodiments, wind turbines may be disposed elsewhere on the power-producing wall 1600; for example, according to an exemplary embodiment, one or more floors of the building may be taken up by wind turbines, such that wind may pass through the building without disrupting the activities of the occupants, if desired. In other exemplary embodiments, a solar system may be combined with a kinetic flap system in which one or more of the kinetic flaps feature solar panels and are disposed in an angled direction, such that wind energy agitates the kinetic flaps when the wind is blowing and such that the solar panels are illuminated for the majority of the day. Other configurations may also be understood, as may be desired.

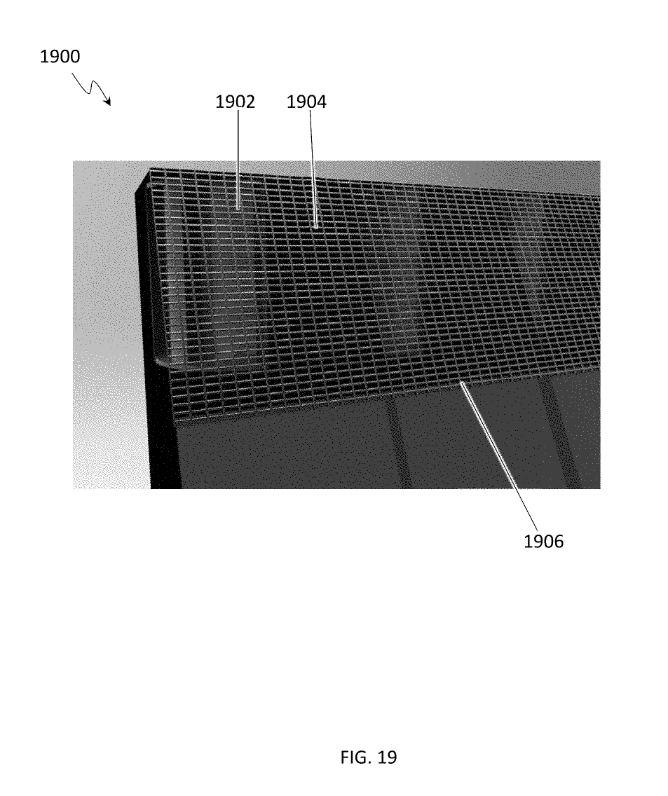

Turning now to exemplary FIG. 19, FIG. 19 shows an exemplary embodiment of a power-producing wall 1900, which shows the operation of the turbines 1902 of the power-producing wall 1900 in more detail. The turbines 1902 may be disposed in air passages 1906 and may be disposed behind an aviary safety screen, such as may be desired.

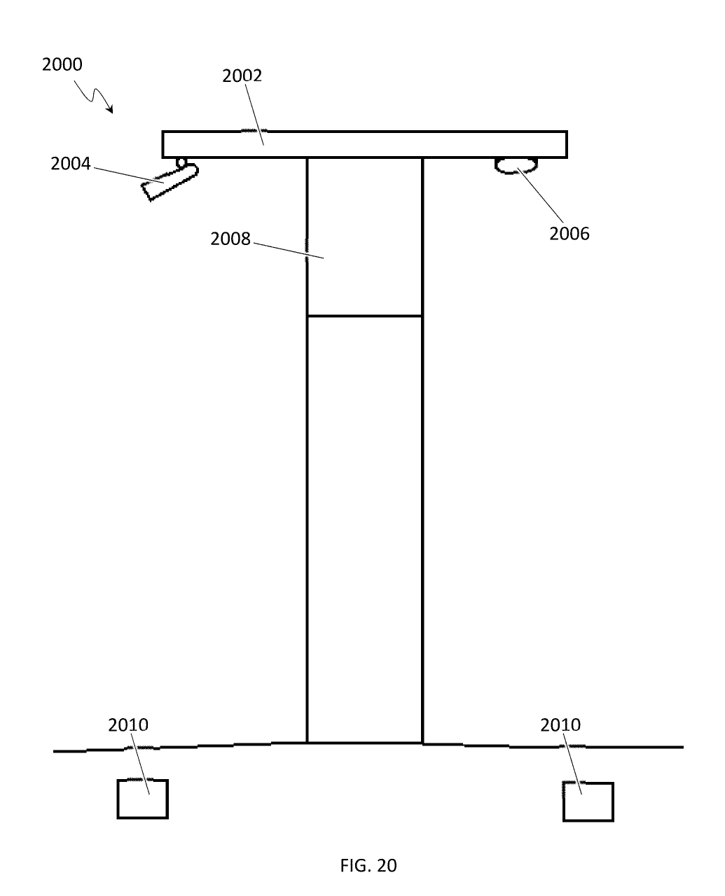

Turning now to exemplary FIG. 20, FIG. 20 shows an exemplary embodiment of a power-producing wall 2000, which may be used as a barrier as well as for power production. According to an exemplary embodiment, a power-producing wall 2000 may have a horizontally-disposed solar panel 2002 mounted at the top of the power-producing wall 2000, and may have one or more rows of wind turbines 2008 disposed in the top portion of the power-producing wall 2000. In some exemplary embodiments, one or more electrical devices may be coupled to and powered by the power-producing wall 2000; for example, according to an exemplary embodiment, a power-producing wall may be coupled to one or more remote cameras 2004, one or more lights 2006, one or more seismic vibration sensors 2010, or any other electrical devices, such as other remote monitoring devices such as motion sensors, battery storage, or the local electrical grid. In an exemplary embodiment, the electrical devices that may be powered by the power-producing wall 2000 may be modular, such that some of the electrical devices may be switched out for other electrical devices as may be desired.

In an exemplary embodiment, a power-producing wall 2000 may be disposed in an east-to-west direction in order to maximize sun exposure. In another exemplary embodiment, a power-producing wall 2000 may be disposed in a north-to-south direction in order to maximize production from the wind turbines, based on the expectation that the wind will most often or most forcefully be blowing west (or east, where applicable). In another exemplary embodiment, the power-producing wall 2000 may be oriented in an intermediate direction, such as may be desired.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art. For example, one such variation is that a power-producing wall may be varied in width and height to have any width or height desired, and, in some exemplary embodiments where the power-producing wall is constructed from modular wall sections, may be constructed from modular wall sections having a variety of widths or heights.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A power-producing barrier wall, comprising:
a frame, the frame having a plurality of shelves, each of the plurality of shelves disposed at a uniform height and disposed in a line in a length direction of the frame, each of the plurality of shelves having a front side opening on a front side of the frame and a back side opening on a back side of the frame, each of the plurality of shelves further having an fluid passageway defined therethrough;
each of the plurality of shelves further having a turbine disposed in the fluid passageway of the shelf, wherein the turbine is free to rotate within the shelf such that movement of fluid through the fluid passageway of the shelf turns the turbine;
the frame further comprising one or more generators, each of the plurality of turbines coupled to the one or more generators by a turbine shaft, each of the one or more generators configured to convert rotary motion of the turbine shaft into electrical power.

2. The power-producing barrier wall of claim 1, wherein the frame comprises a plurality of rows, each row being arranged at a row height and having a plurality of shelves disposed at said row height and disposed in a line in the length direction of the frame.

3. The power-producing barrier wall of claim 1, further comprising a solar panel disposed horizontally on a top side of the frame.

4. The power-producing barrier wall of claim 1, wherein each of the turbines is a vertical-axis wind turbine (VAWT).

5. The power-producing barrier wall of claim 1, wherein each of the turbines is a cross-flow turbine.

6. The power-producing barrier wall of claim 1, wherein each of the turbines is formed from at least one of a plastic or a composite.

7. The power-producing barrier wall of claim 1, wherein each of the turbines is formed from metal.

8. The power-producing barrier wall of claim 1, wherein each of the plurality of shelves further comprises a protective screen disposed over the front side opening.

9. The power-producing barrier wall of claim 1, further comprising an energy storage system, the energy storage system comprising at least one of a battery or a flywheel.

10. The power-producing barrier wall of claim 1, further comprising an electric light electrically coupled to and powered by the one or more generators.

11. The power-producing barrier wall of claim 1, further comprising an electrical outlet electrically coupled to and powered by the one or more generators.

12. The power-producing barrier wall of claim 1, further comprising a powered road de-icing unit electrically coupled to and powered by the one or more generators.

13. The power-producing barrier wall of claim 1, further comprising a foundation, the foundation comprising a shipping container, wherein the frame is disposed on top of the foundation, and wherein the foundation further comprises an energy storage system disposed therein.

14. The power-producing barrier wall of claim 1, wherein the wall is modular, and wherein the frame comprises a plurality of frame elements, each frame element comprising a turbine, each frame element being connected to another frame element by a connector disposed on the frame element.

15. The power-producing barrier wall of claim 1, wherein the wall is modular, and wherein each of the turbines comprises a self-contained turbine cell individually insertable into and removable from the frame.

16. The power-producing barrier wall of claim 1, wherein the frame is disposed on a support base having a sloped side, a plurality of solar panels being disposed on the sloped side of the support base.

17. The power-producing barrier wall of claim 1, wherein the frame is disposed on a hollow support base having a sloped wall comprising solar glass.

18. The power-producing barrier wall of claim 1, wherein the frame is disposed on a hollow support base defining a tunnel extending through the power-producing barrier wall, the tunnel having a maintenance track extending therethrough.

19. A method of using a power-producing barrier wall, the power-producing barrier wall comprising:
a frame, the frame having a plurality of shelves, each of the plurality of shelves disposed at a uniform height and disposed in a line in a length direction of the frame, each of the plurality of shelves having a front side opening on a front side of the frame and a back side opening on a back side of the frame, each of the plurality of shelves further having an fluid passageway defined therethrough;
each of the plurality of shelves further having a turbine disposed in the fluid passageway of the shelf, wherein the turbine is free to rotate within the shelf such that movement of fluid through the fluid passageway of the shelf turns the turbine;
the frame further comprising one or more generators, each of the plurality of turbines coupled to the one or more generators by a turbine shaft, each of the one or more generators configured to convert rotary motion of the turbine shaft into electrical power;
the method comprising:
loading the power-producing wall into a shipping container;
transporting the shipping container holding the power-producing wall; and
deploying the power-producing wall, the step of deploying the power-producing wall comprising coupling the frame to the shipping container such that the frame is disposed on top of the shipping container.

20. The method of claim 16, further comprising coupling the one or more generators to an energy storage system disposed within the shipping container.
